(19) United States
(12) Patent Application Publication
(10) Pub. No.: US 2006/0220273 A1
(43) Pub. Date: Oct. 5, 2006

(54) Process for compression moulding liquid resins with structural reinforcements

(76) Inventors: Bradford D. Armstrong, Barrie (CA); Gregory A. Brower, Fenton, MI (US)

Correspondence Address: Warn, Hoffmann, Miller & LaLone, P.C., P.O. Box 70098, Rochester Hills, MI, 48307, US

(21) Appl. No.: 11/389,958

(22) Filed: Mar. 27, 2006

Related U.S. Application Data
(60) Provisional application No. 60/666,082, filed on Mar. 29, 2005.

(51) Int. Cl. B27N 3/10

(52) U.S. Cl. 264/257; 264/324; 425/398

(57) ABSTRACT

Compression moulding methods and products produced therefrom are provided, including compression moulded products produced from liquid resins having structural reinforcements incorporated therein. A requisite amount of the liquid resin is poured or sprayed into a mould cavity so as to cover the majority of the tool surface. A reinforcing material is then introduced into the mould cavity. The mould is then closed so as compress the liquid resin and wet out the reinforcing material and fill the cavity. The liquid resin is allowed to cure and harden in the mould cavity, whereupon the mould is then opened, and the reinforced structural part is removed.

### CROSS-REFERENCE TO RELATED APPLICATION

This application claims the benefit of U.S. Provisional Application No. 60/666,082, filed 29 Mar. 2005. The disclosure of the above application is incorporated herein by reference.

### FIELD OF THE INVENTION

The present invention relates generally to compression moulding methods and more specifically to compression moulding methods and products produced therefrom, including compression moulded products produced from liquid resins having structural reinforcements incorporated therein.

### BACKGROUND AND SUMMARY OF THE INVENTION

Recently, plastic materials, such as thermoset materials, have been increasingly used in numerous industries to form a host of different types of components. For example, thermoset materials have been employed by the automotive industry to form various automotive components. Thermoset materials are generally lighter than metallic materials, thus allowing automotive manufacturers to reduce vehicle weight and increase fuel efficiency.

One process for forming products comprised of thermoset materials is generally referred to as compression moulding. Compression moulding is generally defined as a method wherein a plastic resin (e.g., a thermoset) is placed in a cavity of a mould and then compressed to form a desired shape or configuration. For example, the plastic resin is placed directly in the bottom cavity of the open, heated mould, and then the top half of the mould is closed down on the plastic resin under the requisite amount of pressure and for the requisite amount of time, causing the plastic resin to flow throughout the cavity until it completely fills the now-closed mould and assumes the shape of the finished part.

Unfortunately, one problem associated with conventional compression moulding techniques and equipment is the relatively long cycle times that are required to cure (i.e., set) common thermoset resins such as but not limited to polyesters, vinyl esters, epoxies, and the like. For example, curing times in the 12 minute range through several hours are not uncommon. These long curing times severely limit the number of parts that can be produced from one compression moulding tool.

Other moulding processes include LFI/compression moulding, Resin Transfer Moulding [RTM], and Prepreg/Compression Moulding. However, none of these conventional moulding techniques appear to provide an adequate solution to the problems encountered in currently available thermoset moulding processes.

Accordingly, there exists a need for new and improved compression moulding methods and products produced therefrom, including but not limited to thermoset resins containing structural reinforcements. It would be desirable to provide a reinforced compression moulded part that can be used in high stress environments, such as a ‘B’ pillar for a vehicle. It would also be desirable to provide a method of making a compression moulded part using shortened cycle times through the aid of improved resins to enhance curability of the part.

Therefore, it is an object of the present invention to provide a new and improved compression moulding system and process, which obviates the disadvantages of the prior art.

It is another object of the present invention to provide a new and improved method for forming a product, wherein the product is formed from a liquid resin and a reinforcing material with continuous oriented fibers so as to enhance structural integrity.

It is still another object of the present invention to provide a new and improved reinforced product, wherein the product is formed from a liquid resin and a reinforcing material with continuous oriented fibers.

In accordance with a first embodiment of the present invention, a compression moulding system is provided, comprising: (1) a compression moulding device, wherein the device includes first and second mould plates having mould face surfaces, wherein a cavity is selectively formed between the first and second mould faces; (2) a first introduction system for introducing a liquid resin into the cavity so as to substantially coat at least one of the first or second mould face surfaces; (3) a second introduction system for introducing a reinforcing material into the cavity; and (4) a system for causing at least one of the first and second mould face surfaces to move towards the other so as to compress the liquid resin in the cavity, wherein the liquid resin substantially wets out the reinforcing material and fills the cavity.

In accordance with a second embodiment of the present invention, a method for forming a product is provided, comprising: (1) providing a compression moulding device, wherein the device includes first and second mould plates having mould face surfaces, wherein a cavity is selectively formed between the first and second mould faces; (2) introducing a liquid resin into the cavity so as to substantially coat at least one of the first or second mould face surfaces; (3) introducing a reinforcing material into the cavity before or after introducing the liquid resin; and (4) causing at least one of the first and second mould face surfaces to move towards one another so as to compress the liquid resin in the cavity, wherein the liquid resin substantially wets out the reinforcing material and completely fills the cavity.

In accordance with a third embodiment of the present invention, a reinforced composite product is provided, wherein the product is comprised of a cured liquid resin and a reinforcing material contained therein. The reinforcing material is made of layers of continuous fibers, each of which has their fibers arranged in predetermined angles to each other.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a compression moulding system, in accordance with a first embodiment of the present invention;

FIG. 2 is a schematic view of a the compression moulding system depicted in FIG. 1, illustrating the liquid resin being introduced into the cavity;

FIG. 3 is a schematic view of the compression moulding system depicted in FIG. 1, illustrating the reinforcement mat being introduced into the cavity;

FIG. 4 is a schematic view of the compression moulding system depicted in FIG. 1, illustrating the mould closed, the vacuum being applied and the optional vibration system being activated to remove air and cure the part;

FIG. 5 is a schematic view of the compression moulding system depicted in FIG. 1, illustrating the mould opened in accordance with a fifth embodiment of the present invention;

FIG. 6 is a schematic view of a compression moulding system depicted in FIG. 1, with the cured part being ejected;

FIG. 7 is a flow diagram for the method of operating the compression moulding system;

FIG. 8 is a fibrous sheet of woven material with lines scribed on it at a 90 degree direction opposite the fibers within the sheet;

FIG. 9 is a perspective view of several fibrous sheets transposed on top of one another showing the orientation of the fibrous materials such that each sheet has its fibers oriented in a direction opposed to the fibers in the adjacent sheet;

FIG. 10 is a side view of the composite layer illustrated in FIG. 9, showing the orientation of the fibers relative to each of the sheets;

FIG. 11 is a pre-form made of the composite or reinforcement mat shown in FIG. 10; and

FIG. 12 is the reinforcement mat depicted in FIG. 11 after having been trimmed and is substantially in a completed form, ready for insertion into the compression mould step shown in FIG. 3.

### DETAILED DESCRIPTION OF THE INVENTION

The following description of the preferred embodiment(s) is merely exemplary in nature and is in no way intended to limit the invention, its application, or uses.

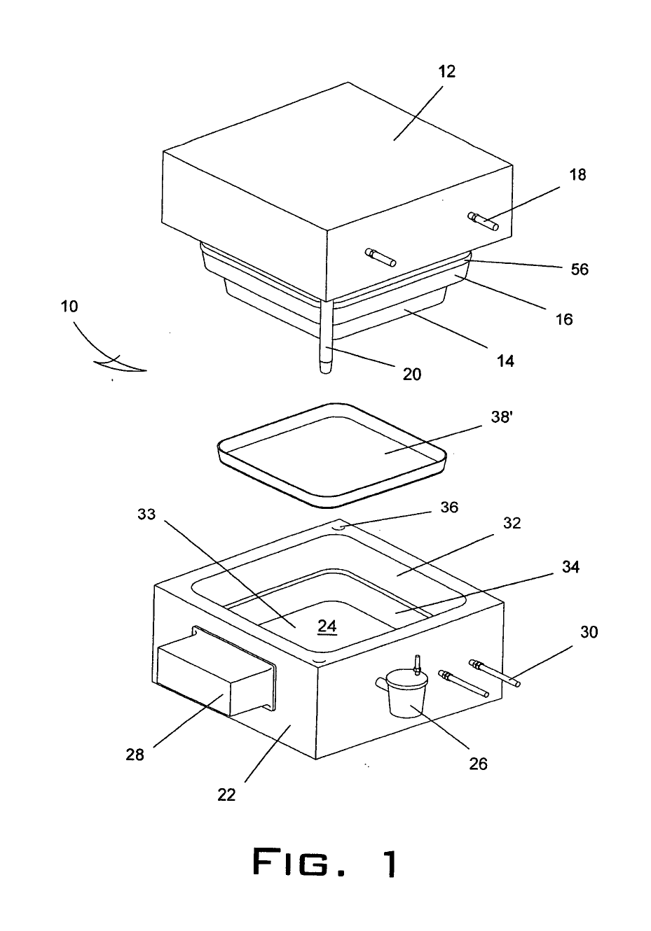

Referring to FIG. 1, a compression moulding system 10 of the present invention preferably includes a male compression mould or core 12, wherein the mould 12 includes mould face surfaces 14 and 16, water lines 18 for heating the mould 12, and a set of guide pins 20. A female mould 22 has a cavity 24, a vacuum system 26, a vibration system 28, and heating lines 30. The cavity 24 has a first surface 32, a second surface 33, and a third surface 34 for receiving mould faces 14 and 16. The seal 56 engages surface 32. The guide pins 20 are received within apertures 36. A pre-formed part 38′ to be moulded is positioned between the moulds.

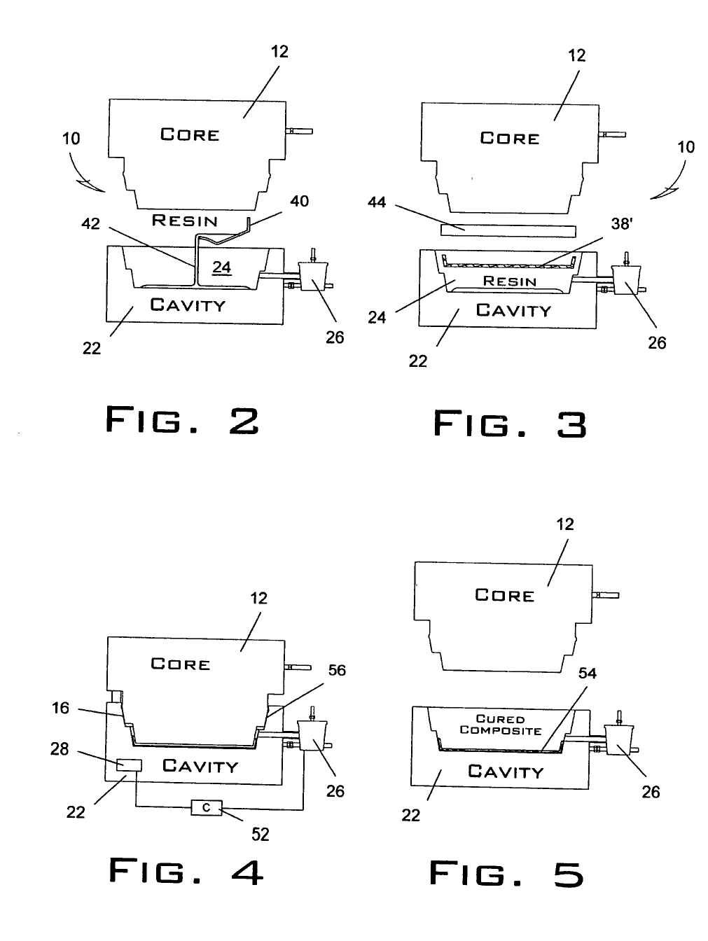

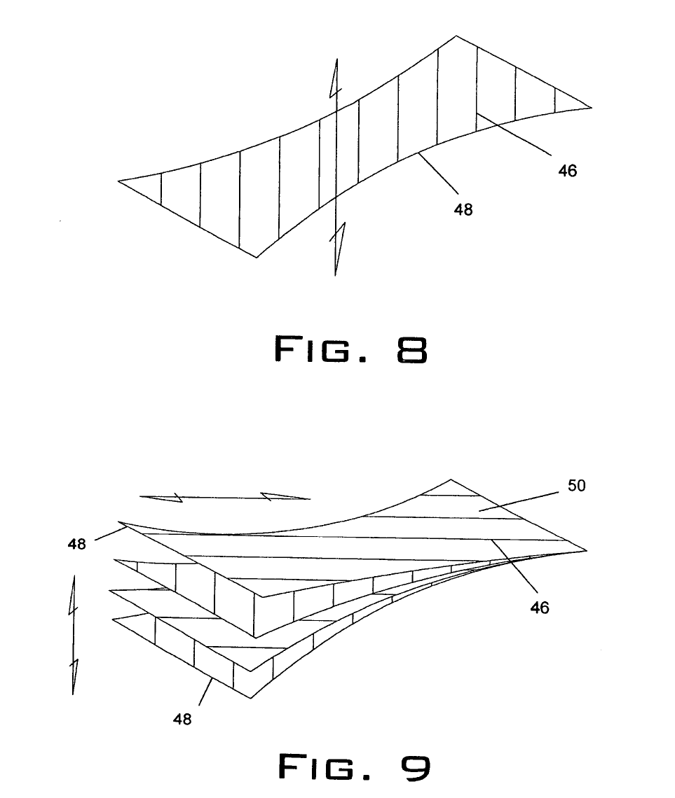

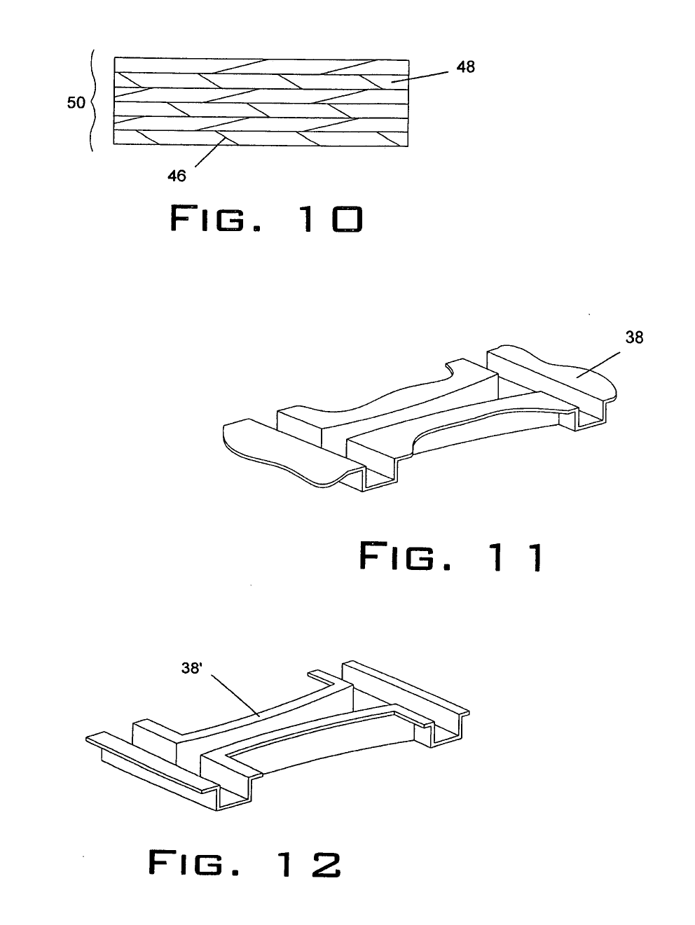

With reference to FIGS. 2 and 3, the system 10 also preferably includes a first introduction system 40 for introducing a liquid resin 42 (e.g., a thermoset and/or the like) into the cavity 24 so as to substantially coat at least one of the mould face surfaces 33 and 34. A second introduction system 44 is for introducing a reinforcing material, such as a mat 38′ (e.g., glass mat, metallic mesh and/or the like) into the cavity 24. By way of a non-limiting example, the reinforcing material 38 can be comprised of oriented continuous fibers 46 that come in roll form or a sheet 48 (FIGS. 9, 10). For example, each sheet or layer 48 can have its fibers oriented at 0, −45, +45, and 90 degrees and can be either stitched or woven to arrange the reinforcement material. It will be readily appreciated and recognized by those skilled in the art that various other orientations can be used as well. The fiber content of each sheet 48 is in the range of about 40 to about 70 percent by weight. By way of a non-limiting example, reinforcing materials useful in the practice of the present invention include, without limitation, glass fibers, carbon fibers, metallic mesh, KEVLAR®, and/or basalt in either fiber or mat forms. It will be appreciated that combinations of these materials can be used to form a composite.

With reference to FIG. 10, the sheets 48 are disposed on top of one another with each sheet 48 having its fibers oriented in different arrangements. Collectively, a multi-layer composite 50 is created that is ready to be made into a pre-form 38. By cross arranging the fiber sheets 48, an improved pre-form is constructed yielding enhanced structural rigidity. It will be appreciated that one could arrange the fibrous sheet in other orientations not shown.

With reference to FIG. 11, a pre-form 38 has been made, prior to the step illustrated in FIG. 3. The pre-form is done in a separate moulding process so as to make the rough shape of a part prior to being inserted into the moulding system 10. FIG. 11 illustrates a roughly shaped part 38 that has not been trimmed which will be used as a “B” pillar in a vehicle. It will be appreciated that the novel system 10 can be used to make parts of many shapes, both complex and flat in configuration. FIG. 12 illustrates the FIG. 11 pre-form 38, after it has been trimmed to a substantially finished configuration 38′ that can now be inserted into the mould cavity 24.

The first and second introduction systems 40, 44, respectively, can comprise manual methods (e.g., an operator physically placing the materials into the cavity 24) or mechanized methods (e.g., nozzles, dispensers, robotic devices, and/or the like) for introducing the required materials into the cavity 24 in the desired sequence.

The system 10 furthermore preferably includes a control system 52 for causing at least one of the mould face surfaces 14, 33 respectively, to move towards one another so as to compress the liquid resin 42 in the cavity 24, wherein the liquid resin 42 substantially wets out the reinforcing material 38′. The control system 52 also preferably is operable to cause at least one of the mould face surfaces 14, 33, respectively, to move away from one another as well.

The system 10 preferably also includes a vacuum system 26 and an optional vibration system 28 in operable association with the system 10 for, among other things, removing air from the system 10 and causing the liquid resin 42 to substantially fully and uniformly wet out the reinforcing material 38′ and fill the cavity 24. The system 10 preferably provides a structural reinforcing and resin system that will completely wet out the reinforcing material 38′ with liquid resin 42 and permit the curing of the liquid resin 42 in less than 5 minutes total cycle time, increasing the repeatability and reducing the number of tools and the capital equipment required. The system 10 will preferably fully wet out the reinforcing material 38 prior to the curing of the liquid resin 52. By way of a non-limiting example, using a polyurethane liquid resin system will allow for the adjustment of the gel/cure time and will optimize the cycle time well under a target of 5 minutes part to part. The reinforcing material 38 can be preformed outside of the moulding operations by having these preforms ready for insertion into the cavity 24 as soon as it is ready. The liquid resin 42 can be poured, sprayed or otherwise introduced in the required amount so as to cover the majority of the tool surface (e.g., mould face surface). This should provide a layer of liquid resin 42 that touches the entire tool surface or the pre-form surface (e.g., mould face surface). The reinforcing material 38′ is then inserted into the cavity 24, and preferably onto the liquid resin 42. The mould halves 12, and 22 are then closed (i.e., the mould face surfaces are brought towards one another) compressing the liquid resin 42 through the reinforcing material 38. This is the shortest path for the liquid resin 42 to take, as the liquid resin 42 has already covered the entire tool surface (e.g., mould face surface). The liquid resin 42 then is permitted to cure and the mould is opened producing a fully reinforced structural composite part 54. The reinforced structural composite part 54 can then be removed from the cavity 24 for immediate use and/or further processing (e.g., painting, de-flashing, and/or the like).

Referring to FIGS. 2-6, an exemplary description of a method for forming a reinforced part 54, in accordance with a preferred embodiment of the present invention will now be described. It should be noted that the sequence of the following particular operations can be varied. By way of a non-limiting example, the reinforcing material 38′ can be first introduced into the cavity 24, with the liquid resin 42 being added subsequently thereto.

FIG. 2 illustrates the mould in its open position with the resin 42 being poured in via the first introduction system 40. It will be appreciated that the resin can be poured or sprayed in to substantially cover the surfaces 33 of the cavity 24 or sprayed on the pre-form 38, or any combination thereof. It is possible to spray only the surfaces 14, 16 on the male mold 12, or only the surfaces 32, 33, 34 on the female mold 22, or a combination thereof. As shown in FIG. 3, the pre-form 38′ is inserted via a second introduction system 44 into cavity 24. The pre-form 38′ is positioned on top of the resin, or alternatively, the steps of FIGS. 2 and 3 can be reversed thus allowing the pre-form 38′ to be inserted into the mould cavity first, with the resin 42 being introduced thereafter.

With reference to FIG. 4, the mould halves 12 and 22 are then closed until the lip seal 56 meets the surface 32. At this point, the vacuum system 26 is activated, thus initiating the vacuum process. As the mould continues to draw a vacuum, the press continues to close the mould to form a seal. The control system 52 on the press controls this process. The mould closes the rest of the way and continues to draw the vacuum while the press applies its tonnage. Once the part is cured, vacuum is removed, tonnage is released and the mould is opened.

Preferably the cure time once the mould closes, and once the part is cured and ejected, is approximately 180 to 240 seconds. This is substantially less than conventional moulding cycle times.

An alternative embodiment provides a vibration system 28 that can be activated on or near the time the vacuum system 26 is operable. The vibration system creates a low frequency pulse that dislodges small air bubbles that are attached to the resin and or the reinforcement matrix and allow them to escape to the edge of the part and out through the parting line of the mold. The resulting part has fewer voids, preferably less than 2%. It will be appreciated that the control system 52 operates the vacuum system 26 and the vibration system 28, as required.

FIG. 5 illustrates the step of the male mould 12 opening up and separating from the female mould 22 so as to expose the cavity 24. The cured completed part 54 can then be removed from the mould as illustrated in FIG. 6.

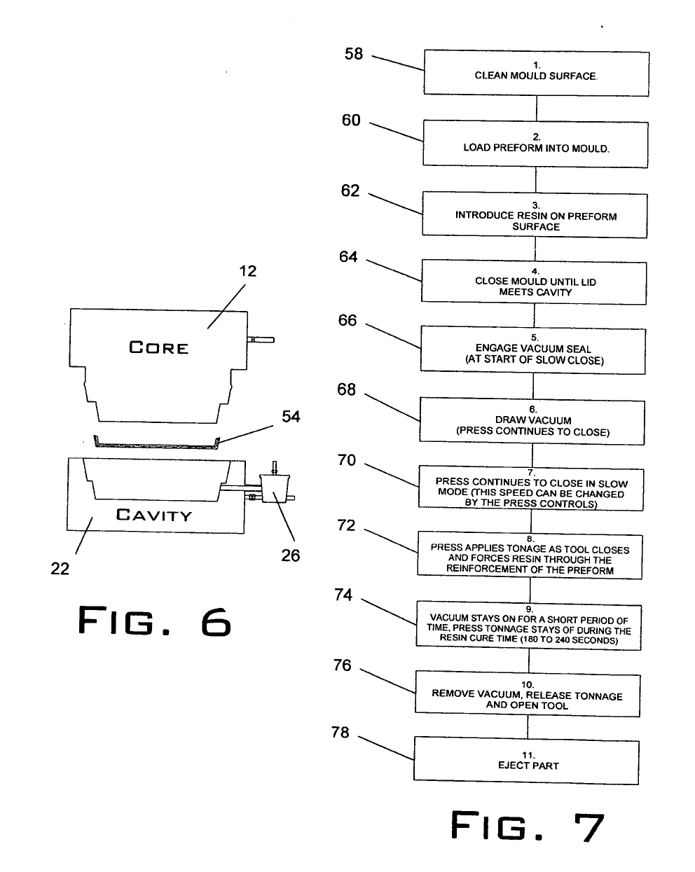

FIG. 7 illustrates a method of forming a compression moulded part using reinforced material. The first step requires cleaning the mould surface 58 free of impurities. The next step 60 requires loading a pre-form 38′ into the mould. This pre-form was made utilizing a separate pre-moulding process that converts the sheets of composite material 50 into a pre-form 38′. The next step 62 requires introducing the resin 42 onto the surface of the pre-form 38′. The next step 64 requires closing the mould until the lip seal 56 meets the cavity. The next step 66 requires engaging a vacuum seal to draw vacuum. A vacuum is then drawn 68 while the press continues to close. The press continues to close in a slow mode 70 which can be controlled by the control system 52. The next step 72 is when the press applies tonnage to the tool causing the tool to close and force the resin through the reinforcement or fibers of the pre-form 38′.

The next step 74 requires maintaining the vacuum for a short period of time while maintaining the press tonnage. It is preferred that the cure time is between 180 to 240 seconds.

The next step 76 requires removing the vacuum, releasing the tonnage, and then opening the tool. Finally, the part is ejected 78, thus allowing the steps to be repeated.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A compression moulding system, comprising:
a compression moulding device, wherein the device includes first and second mould face surfaces, wherein a cavity is selectively formed between the first and second mould faces;
a first introduction system for introducing a liquid resin into the cavity so as to substantially coat at least one of the first or second mould face surfaces;
a second introduction system for introducing into the cavity a reinforcing material having cross-oriented fiberous sheets; and
a system for causing at least one of the first and second mould face surfaces to move towards the other so as to compress the liquid resin in the cavity, wherein the liquid resin substantially wets out the reinforcing material and fills the. cavity.

2. The invention according to claim 1, further comprising allowing the liquid resin to cure in the cavity so as to form a hardened reinforced composite product.

3. The invention according to claim 2, wherein the liquid resin cures in less than 5 minutes.

4. The invention according to claim 2, further comprising removing the hardened reinforced composite product from the cavity.

5. The invention according to claim 1, wherein the liquid resin comprises a thermoset.

6. The invention according to claim 1, further comprising a vacuum system in operable association with the compression moulding device.

7. The invention according to claim 1, further comprising a vibration system in operable association with the compression moulding device, said vibration system being operable to remove air particles from the liquid resin.

8. A method for forming a product, comprising:
providing a compression moulding device, wherein the device includes first and second mould face surfaces, wherein a cavity is selectively formed between the first and second mould faces;
introducing a liquid resin into the cavity so as to substantially coat at least one of the first or second mould face surfaces;
introducing a reinforcing material into the cavity before or after introducing the liquid resin; and
causing at least one of the first and second mould face surfaces to move towards one another so as to compress the liquid resin in the cavity, wherein the liquid resin substantially wets out the reinforcing material and completely fills the cavity.

9. The invention according to claim 8, further comprising allowing the liquid resin to cure in the cavity so as to form a hardened reinforced composite product.

10. The invention according to claim 8, wherein the liquid resin cures in less than 5 minutes.

11. The invention according to claim 8, further comprising removing the hardened reinforced composite product from the cavity.

12. The invention according to claim 8, wherein the liquid resin comprises a thermoset.

13. The invention according to claim 8, further comprising the step of vibrating the compression moulding device in order to remove air from the resin.

14. The invention according to claim 8, further comprising the step of applying a vacuum to the compression moulding device.

15. The invention according to claim 8, wherein the reinforcing material is comprised of a plurality of sheets, each sheet having fibers arranged differently than the fibers of an adjacent sheet.

16. A reinforced composite product made in a compression moulding operation, wherein the product is comprised of a cured liquid resin and a reinforcing material contained therein, the reinforcing material having more than one layer.

17. The invention according to claim 16, wherein the liquid resin is compressed so as to substantially wet out the reinforcing material and completely fill the cavity.

18. The invention according to claim 16, wherein the liquid resin cures in less than 5 minutes.

19. The invention according to claim 16, wherein the liquid resin comprises a thermoset.

20. The invention according to claim 16, wherein the composite product has no more than 2% voids.
